(19) United States
(12) Patent Application Publication
(10) Pub. No.: US 2002/0174090 A1
(43) Pub. Date: Nov. 21, 2002

(54) Wireless real estate for sale signs, sales information

(76) Inventor: Kevin T. Dexter, San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/858,302

(22) Filed: May 15, 2001

(51) Int. Cl. G06F 7/00

(52) U.S. Cl. 707/1

(57) ABSTRACT

A method and a system for obtaining descriptions and commercial terms of properties for sale via a wireless communications device. In one embodiment, a computer-implemented method and system that facilitates the retrieval of information describing a parcel of real property via a wireless communications channel. The method includes configuring a real property inventory database with information describing a plurality of parcels of real property. The information includes property codes associated with the parcels with each property code associated with a parcel data set that includes an offering price for the parcel. The property code of the parcel of land is received in a mobile communications device in response to a user inquiry. The property code is stored in association with a user identification code in a user database. In response to a user control, the mobile communications device retrieves a first parcel data set corresponding to the property code from the real property inventory database of a remote data processing system. The remote data processing system transmits the first parcel data set to a user-selected destination.

### FIELD OF THE INVENTION

The present invention generally relates to retrieving real estate related information and more particularly to obtaining a description of a parcel of realty via a wireless device.

### BACKGROUND OF THE INVENTION

There are times while driving through a particular neighborhood when a prospective home buyer finds a home or parcel of land that is of interest, but there is little or no information available about the property at that particular moment. One option for the prospective buyer is to call the real estate agent advertising the property to obtain more information about property. If the agent is not available, the buyer must leave a message and wait for a return telephone call. If a sales agent accompanies the buyer, the sales agent may have a Multiple Listing Service (MLS) description, but the listing may not be current if it's in printed form or is an earlier download of an electronic form.

In the case where the buyers are relocating, or the buyers are pressed for time, having a minimum amount of information (price and house/parcel size) immediately available is critical to the buyer's decision. With such information the buyer can decide whether to continue pursuing a particular parcel of realty or move on to another location. In this example, the seller loses a valuable opportunity to make a strong initial impression if the property information is not easily and immediately available to the buyer.

In another related example, a buyer may happen upon a parcel of land that he is interested in but a property address is not yet available. The property may have a property code assigned to it but obtaining the property code may require contacting a real estate agent or require searching through the county property database for the information. Both options are inconvenient since contacting the real estate agent or searching county records may require a greater investment in time than the buyer has allotted. It would be highly desirable to have a method and a system for retrieving real estate related information in real time and while remotely located from a data processing system having a realty database.

A method and a system that address the aforementioned problems, as well as other related problems, are therefore desirable.

### SUMMARY OF THE INVENTION

The present invention is directed to addressing the above and other needs in connection with the automatic identification and/or retrieval of real estate related information generated in response to a prospective buyer's inquiry. With the present approach, a prospective buyer subscribes to a service that, in response to an inquiry, sends sales data on a prospective parcel of realty to the subscriber's mobile communications device. The present approach also facilitates the purchase of a parcel of realty by initiating the mortgage pre-approval process with a financial institution. According to one aspect of the invention, a computer-implemented method and system facilitates the retrieval of information describing a parcel of real property via a wireless communications channel. The method includes configuring a real property inventory database with information describing a plurality of parcels of real property. The information includes property codes associated with the parcels with each property code associated with a parcel data set that includes an offering price for the parcel. The property code of the parcel of land is received in a mobile communications device in response to a user inquiry. The property code is stored in association with a user identification code in a user database. In response to a user control, the mobile communications device retrieves a first parcel data set corresponding to the property code from the real property inventory database of a remote data processing system. The remote data processing system transmits the first parcel data set to a user-selected destination.

In a related example embodiment, the real estate information retrieval system further includes a user-profile database accessible by a vendor managed data processing system that is configured to store a set of demographic data in association with the user identification code. Each user's retrieval of parcel data sets from the real property inventory database generates demographic data on each user.

The above summary of the present invention is not intended to describe each illustrated embodiment or every implementation of the present invention. The figures in the detailed description that follow more particularly exemplify these embodiments.

### BRIEF DESCRIPTION OF THE DRAWINGS

Various aspects and advantages of the invention will become apparent upon review of the following detailed description and upon reference to the drawings in which:

FIG. 1 is a block diagram of a realty information retrieval system configured in accordance with an example embodiment of the invention; and

FIG. 2 is a flowchart illustrating an example process in which a description and commercial terms of a parcel of realty are retrieved in accordance with an example embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Various embodiments of the present invention are described in terms of obtaining, from a remote location, descriptions and commercial terms of properties for sale via a mobile communications device. Those skilled in the art will appreciate that the invention could be implemented in a variety of programming languages, computer platforms and communications systems.

In an example embodiment, a registered user of a real estate information retrieval system uses a mobile communications device, such as a cellular telephone, to obtain information on a home for sale. A low power radio transmitter on a realty sign located on the property transmits the property code to the user's personal or automotive radio. The user then keys the property code into the cellular telephone and transmits the code to a data processing system having a real property database therein. A user identification code is appended to the property code transmission to generate demographic data for the vendor providing the retrieval service. The user identification code is assigned when the user completes a user profile in becoming a subscriber to the retrieval system. The real property database is queried, using the property code as the selection criteria, and a parcel data set (e.g., information on the house of interest) is identified. The parcel data set is then sent to the user's cellular telephone for review using the telephone display. In a related embodiment, the latitude and longitude coordinates of the property's location are used as the selection criteria to query the real property inventory database for the parcel data set.

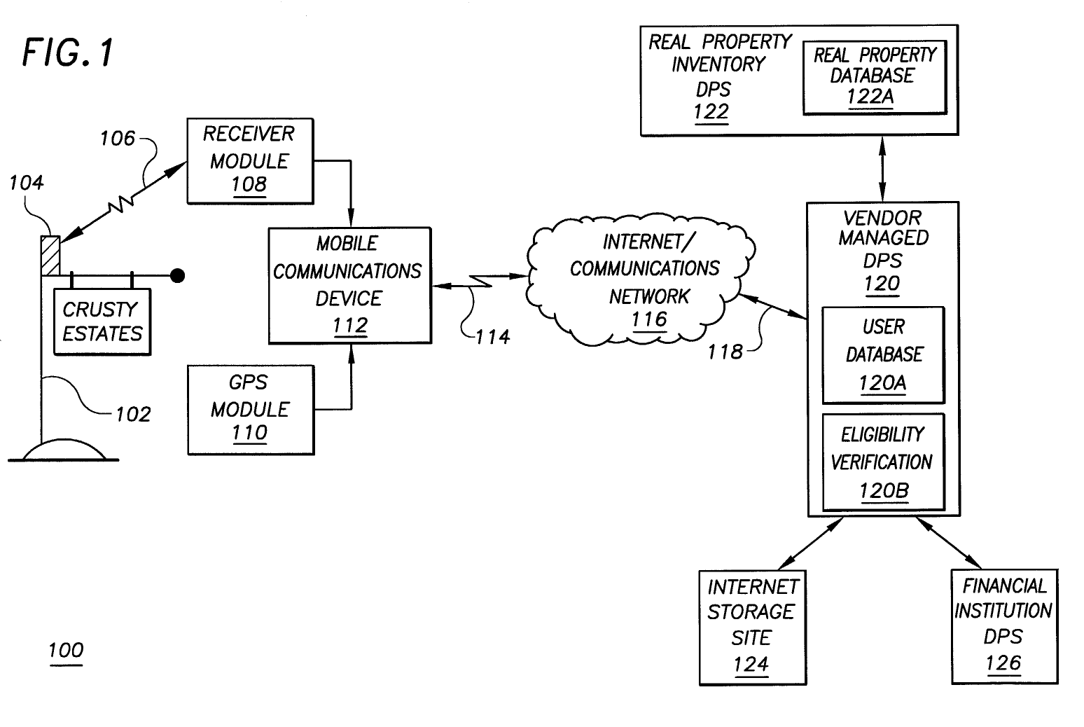

Referring now to the figures, FIG. 1 is a block diagram of a realty information retrieval system 100 configured in accordance with an example embodiment of the invention. For purposes of this application, a parcel of real property includes a fully developed residence or building or an undeveloped parcel of land. Realty retrieval system 100 enables the user to retrieve from a remote location a description and commercial terms of a parcel of property. The user first registers to use the realty information retrieval system 100 by completing a user profile that includes information about the user and the type of communication equipment that the user will use to access a remote data processing system. The registered user is provided with a user identification code that is used for eligibility verification, demographic data collection, or user access to the remote data processing system or to a user-designated storage location.

The user accesses the remote data processing system (e.g., DPS 120) by using a mobile communications device 112, such as a mobile telephone, a PDA or a portable laptop computer coupled to a wireless modem (each having therein data processing capabilities). Mobile device 112 receives from receiver module 108 or GPS module 110 a property code that is later used to obtain more information about the property of interest. In one embodiment, the user sends the property code and the user identification code to a remote data processing system to automatically retrieve the property description (or parcel data set) associated with the property code. The user receives from DPS 120 at the mobile device 112 the property description and sales price. For purposes of this application, the property code includes, but is not limited to, a property address, a set of geographic coordinates, an MLS description code or any code used in a real property database to identify a parcel of realty.

In this example embodiment, system 100 includes a transmitter device 104 mounted on a realty sign 102 that is located on a parcel of real property. Transmitter 104 transmits via a wireless communications channel (wireless, including radio, cellular, etc.) information to a receiver module 108. Receiver module 108 is a personal or automotive radio that receives radio wave communications from transmitter 104 that describe the property for sale or provides the property code. The user then keys the property code information into mobile communications device 112. In another example embodiment, voice recognition software enables mobile device 112 to receive the property code via the voice commands of the user.

In yet another example embodiment, mobile communications device 112 is an automotive communications system that has wireless communications capabilities (e.g., OnStar) that has receiver 108 integrated therein for receiving radio and satellite broadcast communications. Signals received from transmitter 104 are immediately decoded and appear on a display of the automotive communications system. In a related embodiment, the automotive communications system is configured with Internet browsing capabilities to provide immediate access to the Internet and to DPS 120. In another related embodiment, a cellular telephone or a PDA, similar to the automotive communications system, includes a radio receiver that receives and decodes signals received from transmitter 104.

Mobile device 112 is coupled to a communications network 116 (the Internet or the PSTN) via a wireless communications channel 114. Communications network 116 facilitates communication via a communications channel 118 with vendor managed data processing system 120. Upon receiving a user command, mobile device 112 transmits the property code displayed to the vendor managed DPS 120. In a related embodiment, mobile device 112 automatically transmits the property code to DPS 120. Displays coupled to mobile communication devices include CRT monitors, LCD displays, thin film displays, cellular and regular telephone displays and personal digital assistant displays. These communications devices can access communications network 116 to download application software or to retrieve data from user-designated storage locations.

In another embodiment, mobile device 112 is coupled to a GPS (global positioning system) module 110 for purposes of receiving a set of geographic coordinates (latitude and longitude) of a parcel of property. Once the coordinates of the property are known, the coordinates are submitted to a geographic information system (e.g., MapsOnUs.com) to determine the address or range of property addresses that are close to the coordinates given. The range of addresses obtained from the geographic information system are then entered into DPS 120 to determine which property is actually available for sale.

In this example embodiment, DPS 120 is a server that is coupled to a real property inventory DPS 124 that includes a database 122A having a listing of parcels of property for sale. The listing includes vacant lots, residential and commercial buildings and parcels of land that are each identified with a property code. Each parcel is associated with a parcel data set, which at a minimum includes a property code identifier and a sales price. In another embodiment, the parcel data set also includes lot size and dimensions, location, taxes, description of the house or building thereon, etc. Vendor DPS 120 is also coupled to an Internet storage site 124 that stores information describing the property or properties that the user is interested in. Depending on the configuration selected by the user, the parcel data set identified in the real property database is either sent to mobile device 112 or is sent to a user-designated storage location (e.g., Internet storage site 124). Where the parcel data set is sent to the user-designated storage location, the user retrieves the data set using his user ID code and mobile device 112. In yet another embodiment, the storage site also includes data such as the property code and the full detailed description of the property of interest. Vendor DPS 120 is also coupled to a financial institution DPS 126 for facilitating the search for mortgage rates, for securing pre-approval of a mortgage loan or for conducting a credit check. Vendor DPS 120 includes a user database 120A and an eligibility verification database 120B. In an example embodiment, user database 120A includes a user profile database.

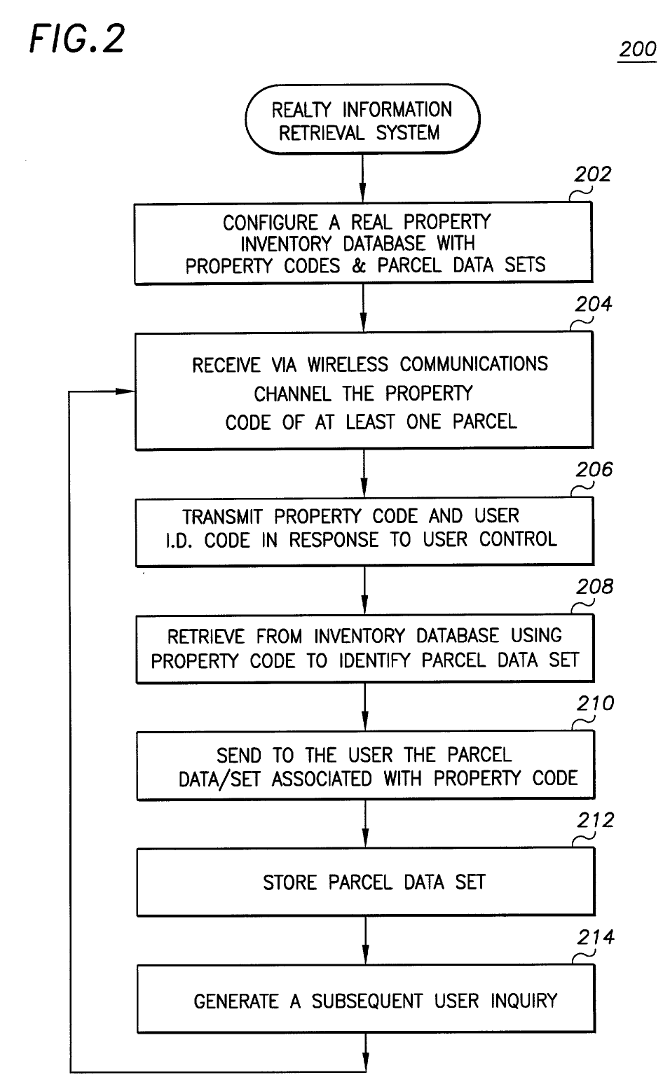

Users of retrieval system benefit since the property description and sales price are automatically retrieved without undue searching while vendors (sellers and realty agencies) benefit since sales leads for property purchases are more developed before agents get involved. In addition, user profile data and levels of usage by users are used to develop demographic data about purchasing interests of users. In a related embodiment, DPS 120 further includes a user-profile database configured to store a set of user-provided data that characterizes the user in association with the user identification code. Data for the user-profile database is usually generated when users complete the user profile and are given the user ID code. The user-profile database is also configured to store selected parcel data sets in association with the user identification code. The operation of system 100 will be described in more detail in connection with the discussion of FIG. 2.

Referring now to FIG. 2, a flowchart 200 illustrates an example process in which a computer implemented realty information system 100 retrieves the description and commercial terms of the parcel of realty via the wireless communications channel. At step 202, a real property database 122A of real property inventory DPS 122 is configured with information (or parcel data sets) describing a plurality of properties for sale along with property codes. One example of such a database is the multiple listing service (MLS), which provides property descriptions as well as sales prices. A user of system 100 first downloads application software to mobile device 112 (or to a portable computer) in order to have access to system 100. In one example embodiment, the application download process includes completing a user-profile in order to obtain a user identification code, the user ID code being used for accessing and navigating within DPS 120. In another example embodiment, the user identification code includes an additional identifier of the type of device, mobile or computer terminal, used to access DPS 120.

At step 204, as the user is previewing properties the user finds a property of interest. In one example embodiment, transmitter 104 located on sign post 102 continuously sends a low power radio signal 106 that includes information about the property for sale and a property code. The automobile's radio or navigation system, a separate portable radio or communications device 112 (or via a Wireless Application Protocol (WAP) enabled communications device) receives the signal from transmitter 104. In another example embodiment, GPS module 110 receives the property code, of the property that the user is currently previewing, in the form of a set of geographic coordinates. Mobile device 112 accesses a geographic information system and uses the geographic coordinates to obtain at least one property address (or a small range of addresses). At step 206, the user keys the property code or address into mobile device 112 and transmits the information to vendor managed DPS 120 by pressing a button on device 112. Upon transmission, the user ID code is automatically appended to the property code and stored in user database 120A of DPS 120. In one example embodiment, the property code and the user ID code are temporarily stored in mobile device 112 (or in a computer).

At step 208, DPS 120 retrieves the parcel data set by using the property code to search real property inventory database 122A for the corresponding property description. In another example embodiment, before the property at issue is identified or the parcel data set retrieved, the user ID code and the property code are used to conduct an optional eligibility query with eligibility verification database 120B disposed within DPS 120. The eligibility query ensures that the user is registered with the information retrieval system by verifying registration against the user profile. In another embodiment, the user profile is also used to track requests for the particular user and to gather other demographic data from the user to augment the profile. Once the eligibility verification step is complete, DPS 120 automatically queries database 122A and retrieves the parcel data set corresponding to the property code.

At step 210, DPS 120 sends the parcel data set via wireless communication channel 114 to the user at mobile device 112 to complete the retrieval request. At step 212, the parcel data set corresponding to the property code is associated with the user ID code and is stored in the user-designated storage location (which includes either the memory of mobile device 112 or Internet storage site 124). The user is then free to access any of the storage locations to retrieve the parcel data set at another time. At step 214, DPS 120 is ready to process another realty information request that is sent by the same or another user. In another embodiment, the user receives only part of the parcel data set (such as the offering price and square footage) at mobile device 112 and the remaining data is sent to the user-designated storage location (such as site 124) where it is retrievable using the user ID code. In this example embodiment, the user-designated storage sites keep a history of retrieval requests as well as the full property descriptions of the properties identified. In another example embodiment, responses to requests that are sent to DPS 120 can be tagged with a “cookie” in order for the realty agency to recognize a repeat user of DPS 120 and for collection of demographic data.

In another example embodiment, a business rule suggests that as DPS 120 sends the parcel data sets to the user, additional data sets on similar properties should also be sent to the user. When the user reviews the additional data sets, any interest demonstrated in the additional properties generates behavioral data that is stored in the user profile database for later reference. In this manner, the vendor/agency learns more about the user's interests and the user learns more about what the vendor has to offer. In another embodiment, data sets include information in the form of maps and/or directions to similar properties that are close to the user's current location. This information is communicated in real time or is saved as stored messages. As automotive navigation systems evolve, the automotive systems will be integrated with wireless services so as to provide navigational information from geographic coordinates that are obtained in connection with prospective properties. With these systems, some or all of the information provided by DPS 120 can be downloaded from the automobile's navigation/communication system.

The present invention is believed to be available to users of personal computers, cellular telephone, PDAs, pagers, automotive navigation systems and other digital communication devices that are capable of downloading application software to access the described service. The present invention has been found to be particularly useful in reducing the time and effort a prospective buyer spends in retrieving information on a property of interest and in effecting its purchase. Certain implementations of the present invention also have the advantage of incrementally developing a database on each user's interests without requiring regular updates of the user profile. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A computer-implemented method for retrieving information describing a parcel of real property via a wireless communications channel, the method comprising:
configuring a real property inventory database with information describing a plurality of parcels of real property, the information including property codes associated with the parcels, and each property code associated with a parcel data set that includes an offering price for the parcel;
receiving wirelessly in a mobile communications device the property code of at least one parcel;
storing the property code in association with a user identification code in a user database;
in response to a user control, retrieving with the mobile communications device a first parcel data set corresponding to the property code from the real property inventory database of a remote data processing system; and
transmitting the first parcel data set from the remote data processing system to a user-selected destination.

2. The method of claim 1, further comprising after transmitting the first parcel data set, storing the first parcel data set in a user-designated storage location associated with the user identification code.

3. The method of claim 1, wherein the step of receiving the property code includes receiving from a low power transmitter disposed on the parcel of real property a signal that includes the property code.

4. The method of claim 1, wherein the step of receiving the property code includes the step of obtaining a set of geographic coordinates of the at least one parcel from a global positioning system.

5. The method of claim 4, further comprising the step of receiving at least one physical address in the mobile communications device from a geographic information data processing system in response to a query that includes the set of geographic coordinates.

6. The method of claim 1, further comprising after transmitting the first parcel data set initiating a mortage pre-approval process with a financial institution data processing system.

7. The method of claim 1, further comprising before receiving the property code:
assigning the user identification code upon completing a user-profile; and
generating a set of demographic data for each user when retrieving from the real property inventory database.

8. The method of claim 7, further comprising before retrieving the first parcel data set verifying eligibility of the user to retrieve the first parcel data set from the real property inventory database.

9. The method of claim 1, wherein the user-selected designation is selected from the group consisting of: the mobile communications device, a user database and a network storage location.

10. A system for retrieving information describing a parcel of real property via a wireless communications channel, the system comprising:
a real property inventory database with information describing a plurality of parcels of real property, the information including property codes associated with the parcels, and each property code associated with a parcel data set that includes an offering price for the parcel;
a mobile communications device configured to receive the property code of at least one parcel;
means for storing the property code in association with a user identification code in a user database;
means, responsive to a user control, for retrieving with the mobile communications device a first parcel data set corresponding to the property code from the real property inventory database of a remote data processing system; and
means for transmitting the first parcel data set from the remote data processing system to a user-selected destination.

11. The system of claim 10, further comprising a transmitter configured to transmit to the mobile communications device a signal that includes the property code.

12. The system of claim 10, further comprising a global positioning device coupled to the mobile communications device and configured to receive a set of geographic coordinates from a global positioning system of the least one parcel.

13. The system of claim 10, wherein the mobile communications device is further configured to receive from a global positioning system a set of geographic coordinates of the least one parcel.

14. The system of claim 13, wherein means for retrieving the first parcel set includes a vendor managed data processing system configured to use the property code to retrieve from the real property inventory database the first parcel data set associated with the property code.

15. The system of claim 11, further comprising a user-profile database accessible by a vendor managed data processing system and configured to store a set of demographic data in association with the user identification code, the demographic data being generated as each user retrieves parcel data sets from the real property inventory database.

16. A computer-implemented method for retrieving information describing a parcel of real property via a wireless communications channel, the method comprising:
configuring a real property inventory database with information describing a plurality of parcels of real property, the information including property codes associated with the parcels, and each property code associated with a parcel data set that includes an offering price for the parcel;
receiving in a mobile communications device the property code of at least one parcel;
transmitting, in response to a user control, the property code from the mobile communications device to a remote data processing system and storing the property code in association with a user identification code in a user database;
retrieving with the remote data processing system a first parcel data set corresponding to the property code from the real property inventory database; and
transmitting the first parcel data set from the remote data processing system to the mobile communications device.
